(19) United States
(12) Patent Application Publication
(10) Pub. No.: US 2008/0097776 A1
(43) Pub. Date: Apr. 24, 2008

(54) Succession Success Probability Assessment System and Associated Methods

(75) Inventors: Loyd H. Rawls, Windermere, FL (US); Jeff Faulkner, Woodstock, GA (US)

Correspondence Address: JACQUELINE E. HARTT, PH.D;ALLEN, DYER, DOPPELT, MILBRATH & GILCHRIST, P.A., P.O. BOX 3791, ORLANDO, FL, 32802-3791, US

(73) Assignee: INTERNATIONAL SUCCESSION PLANNING ASSOCIATION, LLC, Orlando, FL (US)

(21) Appl. No.: 11/875,310

(22) Filed: Oct. 19, 2007

Related U.S. Application Data
(60) Provisional application No. 60/862,289, filed on Oct. 20, 2006.

(51) Int. Cl. G06Q 10/00; G06F 17/40

(52) U.S. Cl. 705/1

(57) ABSTRACT

A system and method for delivering an assessment to individuals currently having an involvement in and those potentially acquiring an involvement in the management of an established business are provided. The system and method include an assessment of a plurality of factors that have been shown to influence the success of a business management transition, an analysis of the assessment, and a reporting of the analysis to the client. By subdividing the assessment and analysis into the plurality of factors, each can be prioritized, addressed independently and remediated as deemed necessary. In a particular embodiment, the succession success assessment and report can be delivered online.

### CROSS-REFERENCE TO RELATED APPLICATIONS

This application claims priority to provisional application Ser. No. 60/862,289, filed Oct. 20, 2006, entitled “Succession Success Probability Assessment System and Associated Methods.”

### BACKGROUND OF THE INVENTION

1. Field of the Invention

The present invention relates to systems and methods for assessing current readiness for a transfer of business ownership and management authority, and, more particularly, to such systems and methods for evaluating a probability that an established business will continue to succeed after a transition of ownership and management.

2. Description of Related Art

Succession planning is undertaken in anticipation of a business changing hands, as could result from the retirement or death of an owner or key executive. Events such as these can severely negatively impact a business if sufficient planning has not been done in advance of a predictable or unpredictable leadership change, particularly, although not exclusively, in closely held companies.

It would therefore be desirable to provide a system and method for assessing and quantifying a readiness for succession and the likelihood of the continuation of business success under new ownership and/or management.

### SUMMARY OF THE INVENTION

The present invention is directed to a system and method for delivering an assessment to individuals currently having an involvement in and those potentially acquiring an involvement in the ownership, leadership, or management of an established business. The system and method include an assessment of a plurality of factors that have been shown to influence the long-term success of a business ownership, leadership, or management transition. The system and method include an analysis of the assessment and a reporting of the analysis to the user/client. By subdividing the assessment and analysis into the plurality of factors, each can be addressed independently and remediated as deemed necessary.

In a particular embodiment, the succession success assessment and report can be delivered online.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1 is a flowchart for an exemplary embodiment of a method of the present invention.

FIG. 2 is an exemplary chart summarizing a global succession score and scores in the ten interdependent succession success factors.

FIG. 3 is an exemplary bar graph of global scores of succession assessment benchmarks.

### DETAILED DESCRIPTION OF THE PREFERRED EMBODIMENTS

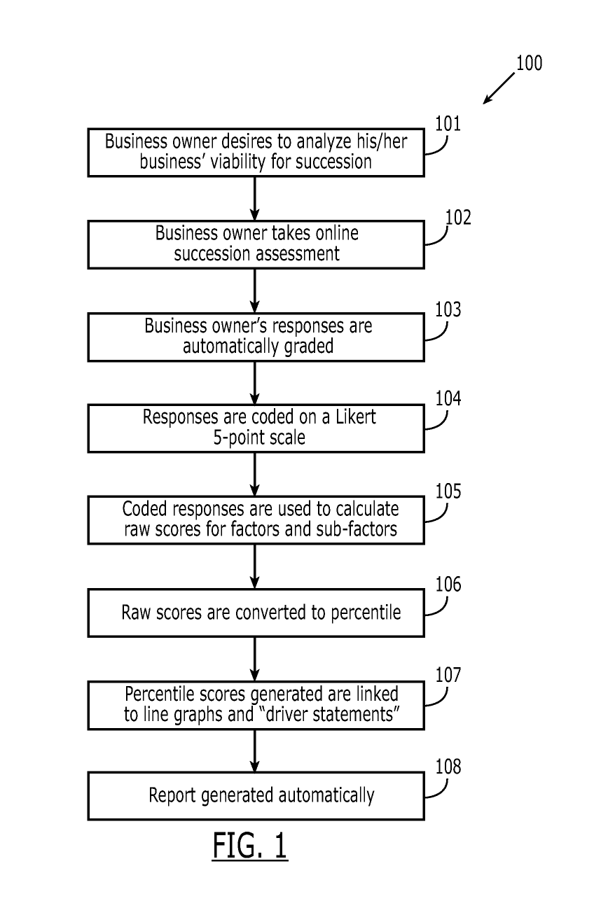

A description of the preferred embodiments of the present invention will now be presented with reference to FIGS. 1-3.

The present invention is directed to a system and method for assessing a probability of achieving business succession through the next generation of owners and managers. In a preferred embodiment, the assessment is administered online, and comprises a plurality of sub-assessments, each intended to isolate a particular factor that can impact the succession success. Several levels of the assessment can be provided, each of which includes an assessment of ten interdependent factors that comprise a “succession matrix.” Ten factors are included here, but are not intended to be limiting on the scope of the invention.

1. Personal Financial Planning (PFP). A fundamental succession planning consideration involves progressively utilizing the fruit of business success to achieve personal financial independence from the business. Financial independence provides the owner the freedom to sell the business for what it is actually worth versus an awkward, costly environment where attempts are made to sell the business to sustain personal security. Additionally, financial independence enables owners to empower succession by incurring the inherent risk or relinquishing control of the business to family members or key managers. Personal financial planning is believed critical to the empowerment of an exit strategy and the continuity of credit from strategic leaders believed critical to the business operation.

2. Business Structuring (BS). Business structuring can also positively or negatively impact the succession of the business. Business structuring has significant impact upon the taxation of earnings and the access of stakeholders to earnings. In the event of a sale, the appropriate corporate or partnership structure would enable stockholders to build tax bases and avoid discouraging taxation on the sales proceeds. Appropriately designed and coordinated stockholder/partner agreements give participating principals the peace of mind that their interests in the business represents real value and that this value cannot be distorted by undesirable stockholder/partners. Employment contracts can enhance exit strategies by authorizing the continuity of compensation and health benefits after retirement or to a spouse after death. The utility or liability of the business to surviving family and key personnel is likely to depend upon the appropriate business structures.

3. Business Performance (BP). Operational success is the value magnet that can draw suitors and compel them to bid up the value of an asset. Operational success is also believed critical to achieving the profitability momentum required to endure predictable challenges to business continuity arising from economic cycles, stakeholder disunity, or family friction, for example. Operational success can and usually does come from a variety of sources such as great location, exemplary product line, or excellent management and service.

4. Strategic Planning (St Plg). Succession planning is fundamentally a long-term strategic issue, and is important to succession success. Everyone understands the cliche, “If you fail to plan, you plan to fail.” It is likely that a business will encounter serious challenges. Change can be a major obstacle. How change is dealt with is a function of the business paradigm.

5. Leadership and Management Continuity (MLC). Much of the value of a business is in the management team that optimizes resources for the achievement of business goals. Therefore, recruiting, training, and empowering a management culture that can sustain and enhance historical success is important to succession success. The identification, motivation, and retention of highly qualified supporting managers are believed essential to maintaining the viability of succession plans. It is also important to examine those who can take it to the next level and begin developing them as key managers. Developing bench strength is important to the strength and sustainability of any team.

6. Successor Preparation (SuP). Skill assessment, training, and appropriate career positioning of people such as family members are critical to building a successful management culture. Family members, for example, should be held to the same standard as any other applicant applying for a management position. Creating and communicating an expectation for entry into the business and/or management can ensure a successor will have proper training, gain the respect of their colleagues, and communicate policy consistency.

7. Management Synergy and Teamwork (MST). Organizational structure, lines of communication, and levels of accountability are extremely important for success in a business environment. The success of a business is largely dependent upon the quality of management. The quality of management is, in turn, usually dependent upon the involvement on a regular basis with the day-to-day intricacies required in operating a profitable operation and the level of communication and teamwork between the senior managers and departments in the business.

8. Family Dynamics (FD). Effective interaction of family members is important to achieve the unity and harmony regarding the complex issues involved in a family business. Otherwise, bickering will undermine the intrinsic strength of the family business team. Effective intra-family communication is important for the training and accountability that are required to develop successor owner managers. Effective communication provides the building blocks for building a unified succession vision and taking the steps for the achievement of family business succession goals.

9. Family Governance (FG). Employment in a family business should be seen as an opportunity, not a birthright. Family members are role models for employees. However, non-family employees can resent family members for a casual “personal property” attitude towards business personnel and equipment. Developing a unity of opinion and adherence to agreements regarding such things as family member compensation and employment perquisites can lead to sustainability, less vulnerability to bad attitudes by employees, and less friction among family members.

10. Owner Motivation and Perspective (OM). A business owner can view the business as “What can it do for me?,” which can trickle down to and negatively affect the stewardship responsibility of owners to their employees, management, and community. A business can take on the personality of the business owner and can either be a positive force and attract good people and business or a negative force and slowly discourage business and a productive work environment. Additionally, although a business may have become very successful by making hard decisions, it is still important for a business owner to be open to suggestions and concerns of the management team they have built. Motivation of a business owner is also critical to the succession of a business. The owner must recognize the benefits of succession and either drive or cooperate in a succession process that provides successors the opportunity to assume responsibility and prove their ability. Developing an exit strategy is important to allow the presumptive successor time to learn and make mistakes while the business owner is still accessible.

It will be understood by one of skill in the art that an assessment such as disclosed herein can be used in succession of a family business through the next generation of leadership, but that the word “family” is not intended to imply that the system is only intended for family-owned and -run businesses, or other types of closely held businesses.

Additional success factors that can be considered, but are not intended to be limited to: credit continuity, non-business investments, estate planning, exit strategy, franchise continuity, estate documentation, probate avoidance, estate tax financing, family understanding of estate plans, business documentation, business profitability, business capitalization, mission statement, vision, core values, supporting management talents, supporting management experience, successor management experience, successor owner training, successor management confidence, customer satisfaction, employee satisfaction, family involvement, family harmony, and owner humility.

In a particular embodiment the assessment comprises a large number of questions, for example, over 200 questions, that are administered online, although any combination of questions may be utilized. As an example, depending upon responses to general parameter questions such as marital status, the presence of family members, partners, or specific business structures, the number of applicable questions varies with each assessment. The assessment is statistically validated, utilizing Lawshe's content validity ratio, and provides a comprehensive, detailed measurement of preparation for the predictable challenges associated with the transition of owners, leadership, and management to and through the next generation.

In a first, basic assessment, a relative percentile scoring of the client's standing in each of the identified critical areas is provided, accompanied by an explanation of specific succession planning assets and succession planning liabilities that can potentially impact the achievement of succession goals. A comprehensive summary assessment provides a general evaluation of overall succession standing, referred to as “succession success positioning” which can be utilized for relative comparison to other businesses in similar industries or similar circumstances. The summary conclusion serves as a valuable tool to the business owner, leader, or manager in evaluating, initiating, or updating succession planning. A trained succession appraiser can interpret the interrelationship of factor scoring to provide valuable guidance regarding the development of a prioritized succession planning strategy.

In a second, enhanced assessment, a more thorough assessment of and report addressing each of the succession factors is provided. This report provides substantially more analysis of succession preparation by expanding the assessment from ten to more than twenty factors that can impact the achievement of succession goals. The report specifically describes the succession planning assets and liabilities within the expanded areas that can impact business succession as well as a written summary of conclusions that serve as a valuable tool in initiating or updating succession planning. A trained succession appraiser can interpret the interrelationship of expanded factor scoring to provide valuable guidance regarding the development of a prioritized succession strategy and an implementation plan.

In a particular embodiment, a numerical figure representing the probability of succession success is calculated, and a certification of qualification can be provided for the business if the figure is above a certain threshold, for example, 87%, although this is not intended as a limitation. Such a qualification can also be provided if the threshold is met over a certain time period, for example, three out of four consecutive years.

An exemplary flowchart for a method 100 of the present invention, including the use of an inventive assessment, is provided in FIG. 1, wherein the business owner presents concerns about the viability of the business for succession, and desires to analyze the situation (block 101). The business owner can take a succession assessment, for example, online (block 102). The assessment comprises statements that have been statistically validated by an expert panel to measure succession positioning. The responses are automatically “graded” (block 103).

The answers are coded on a Likert five-point scale, with values provided from −2 to 2 ranging from “most descriptive of my situation” (+2) to “least descriptive of my situation” (−2) (block 104). The assigned code numbers are multiplied by the Lawshe's validity ratio figure applicable to the item, yielding raw scores for the ten critical factors as well as the 24 sub-factors (block 105). The validity ratios are typically different for each item responded to.

The raw scores are then used to calculate a percentile according to the following formulas, which are intended to be exemplary and non-limiting (block 106): for an assessment total score, divide the raw score by 2 to yield an adjusted score. Divide the adjusted score by the highest possible raw score, which can vary depending upon the number of questions responded to. This yields a raw percent, to which is added 0.5 to yield an adjusted percentage, which, when multiplied by 100, yields a percentile score. As an example, if a respondent answers all items and obtains a raw score of 240:

240/2=120

120/574.824=0.20

0.20+0.5=0.7=70%

Scoring for each factor follows the same basic formula. However, the highest possible raw score is dependent upon the number of items the respondent answered. For the particular factor raw score being converted, an example might be: A respondent obtains a raw score of 78 on the personal financial planning module.

78/2=39

39/109.996=0.3546

0.3546+0.5=0.8546=85.46%

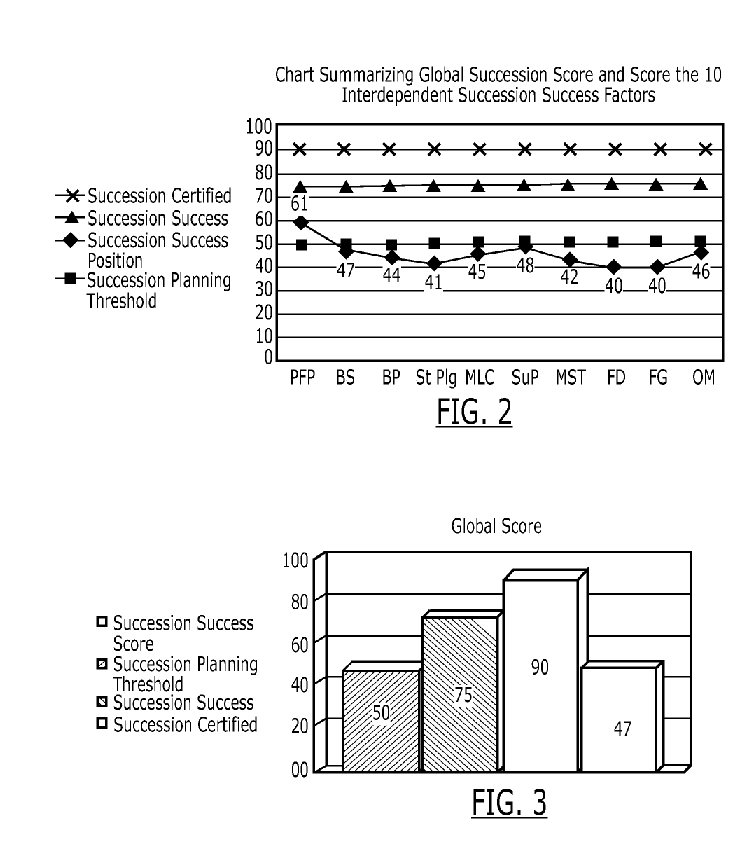

The percentiles are then linked to two items: a line graph that illustrates the scores on each factor (see FIG. 2, for example) and “driver statements” that automatically describe in narrative form the meaning of the percentile scores for each factor (block 107). An exemplary narrative form could be presented as follows:

Observations for Each of the Interdependent
Succession Success Factors
Scoring Key in %

| | |
|---|---|
| 87-100 | A: Excellent |
| 74-86 | B: Good |
| 60-73 | C: Fair |
| 60-under | D: Poor |

Personal Financial Planning—61%. You do not appear to be fully aware of the impact personal financial planning has upon other interdependent aspects of business succession. You apparently have personal financial planning issues that would impact the succession of your business through the next generation. Concerns regarding your personal financial planning appear to have an impact on many succession planning decisions. An assumption that your personal financial planning could support your succession goals would be precarious.

Business Structuring—47%. You appear to be precariously unaware of the impact business structuring and documentation has upon other interdependent aspects of business succession. You apparently have significant business structuring issues that are impacting the succession of your business through the next generation. Concerns regarding your business structuring are impeding other important succession planning decisions. Your business structuring does not appear prepared to support the achievement of your succession planning goals.

Business Performance—44%. You appear to be precariously unaware of the impact business performance has upon other interdependent aspects of business succession. You apparently have significant business performance issues the could block the succession of your business through the next generation. Concerns regarding profitability, working capital, and/or credit continuity are impeding other important succession planning decisions. Your business performance does not currently appear capable of supporting the achievement of your succession planning goals.

Strategic Planning—41%. You appear to be precariously unaware of the impact long-term strategic planning has upon other interdependent aspects of business succession. There appear to be multiple significant strategic issues that are impacting the succession of your business through the next generation. Concerns regarding strategic issues are impeding other important succession planning decisions. Your strategic planning does not appear prepared to support the achievement of your succession planning goals.

Leadership and Management Continuity—45%. You appear to be precariously unaware of the impact leadership and management continuity has upon other interdependent aspects of business succession. You apparently have leadership and/or management issues that are impacting the succession of your business through the next generation. Concerns regarding leadership and management continuity are impeding other important succession planning decisions. There should be no assumption that leadership and management talent will be supportive of your succession goals.

Successor Preparation—48%. You appear to be precariously unaware of the impact preparedness of your successors will have upon other interdependent aspects of business succession. There appear to be significant successor preparation issues that are impacting the succession of your business through the next generation. Concerns regarding successor preparation are impeding other important succession planning decisions. You successors do not appear prepared to support the achievement of your succession planning goals.

Management Synergy and Teamwork—42%. You appear to be precariously unaware of the impact management teamwork and synergy has upon other interdependent aspects of business succession. Apparently you currently have management teamwork issues that are impacting the succession of your business through the next generation. Concerns regarding management synergy are impeding other succession planning decisions. There should be no assumption that management teamwork and synergy will be supportive of your succession goals.

Family Dynamics—40%. You appear to be precariously unaware of the impact family dynamics will have upon other interdependent aspects of business succession. There are apparently significant family relationship issues that are impacting the succession of your business through the next generation. Concerns regarding family harmony are impeding other succession planning decisions. Your family unity does not appear adequate to support the achievement of your succession planning goals.

Family Governance—40%. You appear to be precariously unaware of the impact family governance has upon other interdependent aspects of business succession. You apparently have family control and accountability issues that are impacting the succession of your business through the next generation. Concerns regarding family governance are impeding other succession planning decisions. There should be no assumption that family governance would be supportive of the achievement of your succession goals.

Owner Motivation and Perspective—46%. You appear to be precariously unaware of the impact owner motivation and perspective has upon other interdependent aspects of business succession. You apparently have owner commitment and humility issues that are impacting the succession of your business through the next generation. Concerns regarding owner motivation and perspective are impeding other succession planning decisions. There should be no assumption that the owner's commitment to succession will be an asset towards the achievement of your succession goals.

The calculations can also be used to automatically generate a report in narrative form that indicates the ability to achieve succession success and illustrates areas of deficiency that need to be addressed (block 108). The report includes percentile-based scores and a narrative explanation in a plurality, for example, 24, critical areas of business performance that are indicative of the ability to achieve business succession successfully. The report also clearly illustrates areas of deficiency that need to be addressed.

Additional explanation can be provided as to succession assessment benchmarksas follows:

Succession Success. Within the realm of succession, success is defined as the continuation of a family business legacy through the next generation. As described above, business succession is a formidable challenge due to the multiple, variable, interdependent factors (succession matrix) that can impact the achievement of business continuity goals. “Succession success” is a term that describes the impressive achievement of having effectively addressed all the relevant issues of the succession matrix impacting the continuity if a specific business through the next generation.

“Succession success positioning” describes the individual and cumulative percentile scoring of a specific family business in each interdependent area of the succession matrix relative to the assumed highest possible level(s) of achievement.

The “succession success threshold” is both the individual and the cumulative level of scoring achievement in each interdependent area of the succession matrix that is believed to be required to support succession success. This assessment scoring threshold has been determined and statistically validated by succession experts utilizing historical comparisons to a population of other family business that are successfully addressing the challenges of succession.

“Succession certified” is an honored designation given to those businesses that have effectively and consistently addressed the relevant issues of the succession matrix. In an exemplary embodiment, succession certification is reflected by a cumulative percentile score of 90% or more with the assumption that no individual factor has a scoring of less than 74%. Certification is dependent upon maintenance of this scoring on a rolling three out of four years. “Succession certified” is a prima facia indicator to family members, key managers, employees, and vendors that a business is optimally prepared for continuation of the business through the next generation of ownership and management.

An exemplary overall summary can appear as follows, with graphics such as that in FIG. 3 provided.
As described above, the succession success assessment provides an effective but efficient description of succession success positioning relative to the planning and preparation thresholds of other businesses that our expert panel has confirmed to be qualified as succession certified. We have anticipated that you may want expanded information about the specific succession matrix issues that are impacting the achievement of your succession planning goals and that you may like to review your assessment results with a qualified succession planning professional to answer questions regarding issues that you results highlights. If you would like to receive a substantially more detailed explanation about the specific issues with the 10 interdependent factors of the succession matrix and personally review your results with a certified succession appraiser (CSA), contact [a designated organization through a website, for example].
For additional information on our succession success assessment enhanced, our succession planning review and assessment, and/or the qualifications of a certified succession appraiser (CSA), or certified succession planner (CSP), please visit [a website].

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the system and method illustrated and described herein are by way of example, and the scope of the invention is not limited to the exact details.

What is claimed is:

1. A method for assessing a probability of success of a change in leadership status of a business, the method comprising the steps of:
administering an assessment to a current leader of a business, the assessment comprising a plurality of modules, each module comprising a plurality of items adapted to assess a predetermined factor capable of impacting a success of a change in leadership in the business;
determining a score for each module of the assessment;
correlating the score for each module with an evaluation of a succession success probability for each respective predetermined factor; and
issuing a report to the current leader comprising the evaluations.

2. The method recited in claim 1, wherein the modules are selected from at least two of personal financial planning, business structuring, business performance, strategic planning, leadership and management continuity, successor preparation, management synergy and teamwork, family dynamics, family governance, and owner motivation and perspective.

3. The method recited in claim 1, wherein the assessment-administering step comprises making the assessment available over a network.

4. The method recited in claim 1, wherein the report comprises a relative percentile scoring in each of the modules.

5. The method recited in claim 4, wherein the report further comprises an explanation of succession planning assets and liabilities for achieving succession success.

6. The method recited in claim 1, further comprising the steps of interpreting a relationship between the module scores and providing guidance for developing a prioritized succession planning strategy.

7. The method recited in claim 1, further comprising the step of calculating a probability of succession success based upon the module scores, and wherein the report comprises the probability of succession success.

8. The method recited in claim 1, further comprising the steps of comparing the module scores with a predetermined achievement value, and, if the module scores are above the predetermined achievement value, providing a certification of likelihood of succession success.

9. A system for assessing a probability of success of a change in leadership status of a business, the system comprising:
a processor in signal communication with a network; and
a software package resident on the processor, the software package comprising code segments adapted to:
administer an assessment over the network to a current leader of a business, the assessment comprising a plurality of modules, each module comprising a plurality of items adapted to assess a predetermined factor capable of impacting a success of a change in leadership in the business;
receive answers to the items from the current leader over the network;
determine a score for each module of the assessment;
correlate the score for each module with an evaluation of a succession success probability for each respective predetermined factor; and
issue a report to the current leader comprising the evaluations.

10. The system recited in claim 9, wherein the modules are selected from at least two of personal financial planning, business structuring, business performance, strategic planning, leadership and management continuity, successor preparation, management synergy and teamwork, family dynamics, family governance, and owner motivation and perspective.

11. The system recited in claim 9, wherein the report-issuing code segment comprises a code segment for calculating a relative percentile scoring in each of the modules and wherein the report comprises the relative percentile scoring in each of the modules.

12. The system recited in claim 11, wherein the report-issuing code segment comprises a code segment for correlating the scores for each module with a verbal explanation of succession planning assets and liabilities for achieving succession success, and wherein the report comprises the verbal explanations.

13. The system recited in claim 9, wherein the software package further comprises a code segment for calculating a probability of succession success based upon the module scores, and wherein the report comprises the probability of succession success.

14. The system recited in claim 9, wherein the software package further comprises code segments for comparing the module scores with a predetermined achievement value, and, if the module scores are above the predetermined achievement value, providing a certification of likelihood of succession success.
